(19) United States
(12) Patent Application Publication
(10) Pub. No.: US 2002/0042799 A1
(43) Pub. Date: Apr. 11, 2002

(54) System and method for adding a floating window of the user's choice to a browser's home page

(76) Inventor: Benjamin Slotznick, Mt. Gretna, PA (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/801,511

(22) Filed: Mar. 7, 2001

Related U.S. Application Data
(60) Provisional application No. 60/187,577, filed on Mar. 7, 2000.

(51) Int. Cl. G06F 17/24; G06F 15/16

(52) U.S. Cl. 707/501.1; 707/513; 709/219

(57) ABSTRACT

A method of selecting and displaying two home pages, one appearing in a floating window displayed on a display screen of a user's terminal and the other one appearing in the background of the display screen. A browser in the user's terminal treats a setup page as the user's home page. The setup page retrieves the addresses of two home pages previously selected by the user. One of the home pages is displayed in the floating window on top of the other home page. CGI script is used to predetermine how the display of home pages is to be arranged.

### Cross-Reference to Related Applications

This application claims the benefit of U.S. Provisional Application No. 60/187,577 filed Mar. 7, 2000, entitled “SYSTEM AND METHOD FOR ADDING A FLOATING WINDOW OF THE USER'S CHOICE TO A BROWSER'S HOME PAGE (HOME PAGE PLUS).”

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

When a person accesses the Internet using browser software, the software automatically opens up a particular web site called a “home page” or “start page”. In many browsers (e.g., Netscape Navigator and Microsoft Internet Explorer), this home page can be set by the user to any web page on the Internet (even if initially set by the manufacturer or distributor of the browser software). Many web sites (e.g., Yahoo, New York Times, CNET news) try to convince users to set that site as the user's home page, because doing so will generate repeat traffic and advertising revenue for the web site. Web sites can allow users the ability to customize what is shown on this home page using techniques such as cookies and scripting (e.g., MyYahoo). These web sites restrict what a user can do to customize the home page. Some web sites and web services provide technology to create a personalized home page from various third party web sites (e.g., octopus.com).

Other web and software developers offer small downloadable programs that will place an icon or small window or tool bar on the computer screen for quick access to the site (e.g., Webshot, Alta Vista, HotMail, etc.). The icon or tool bar may blink or make sounds when there is something “new” at the web site. When clicked, the program will direct the current browser to a preset web site, or launch a new browser window and direct it to the preset web site.

Many browsers (including Netscape Navigator and Microsoft Internet Explorer) are designed so that the user can run several instances of the browser concurrently—that is, there can be two browser windows directed to different web sites. To facilitate seeing several program windows at the same time, a user can frequently resize browser windows. Some web sites contain software code (e.g., Javascript, Java, etc.), which allow the user to launch a smaller “floating” window displaying the site (called a “child” window) with a single mouse click (e.g., “joke” sites such as kvetch.com, webcam sites such as anacam.com, chat sites, etc.). This allows the user to continue viewing that web site in the child window, while browsing other web sites in the original “parent” window.

### SUMMARY OF THE INVENTION

The present invention allows a user to keep his favorite home page (“Old Home Page”), but add to his home page a floating window (“Floating Window”) from the same or any other web site. In a preferred implementation, the user chooses a new specially coded Internet address (or “URL”) as his new home page. The code at this URL launches a new Floating Window (displaying content of the user's choice) and redirects the parent browser window to the Old Home Page. After the redirect is accomplished, the user sees the Floating Window in the foreground of the computer screen and the Old Home Page in the background. Using standard commands and techniques the user closes, minimizes, or maximizes either the Floating Window or the Old Home Page window, or toggles between their windows.

A method of supplementing the display of a desired home web page with a Floating Window on a display screen of a user's terminal is now described. A Setup web Page having an address is used to enable the present invention. The Setup Page has access to the address of the Old Home Page and an address of a supplemental web page (e.g., a second home page) to be displayed in the Floating Window. A browser of the user's terminal automatically navigates to the Setup Page address when the user logs onto the Internet. The Setup Page then automatically retrieves the Old Home Page address and the supplemental web page address. Code in the Setup Page automatically launches a browser window and the Floating Window. The browser window displays the Old Home Page. The Floating Window is created to float above the browser window and displays the supplemental web page. In another embodiment, the Setup Page only receives the supplemental web page address and automatically launches the Floating Window. The Floating Window displays the supplemental web page.

The user's terminal may store a cookie file that includes the Old Home Page address and the supplemental web page address. The Setup Page uses address information in the cookie file to automatically cause the Old Home Page and the supplemental web page to be displayed. The Setup Page may be located in a file on the user's terminal or may be remotely located from the user's terminal. The Setup Page may open up at least one other window on the user's display screen to display advertising or other information.

The user may select the supplemental web page by clicking on a displayed page element such as an icon, a link or a button while visiting the supplemental web page. The address of the supplemental web page may then be automatically stored in a cookie file in the user's terminal or in a file on a remote server.

The Setup Page may be an HTML page. The Setup Page may be a CGI script. The CGI script may be configured such that the Floating Window appears in the foreground of the display screen, and the Old Home Page appears in the background of the display screen.

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1 shows an arrangement for displaying a desired first home page and a second supplemental home page in accordance with the present invention;

FIG. 2 shows a flow chart in accordance with the present invention; and

FIGS. 3A and 3B show a “Setup Page” in accordance with the present invention.

### DETAILED DESCRIPTION OF THE INVENTION

Certain terminology is used herein for convenience only and is not to be taken as a limitation on the present invention.

A preferred embodiment of the present invention uses a web page referred to in this patent application as a “Setup Page”. The Setup Page contains a form or forms (“Sign Up Forms”) that allow a user to enter choices for the Floating Window and enter the URL of the Old Home Page. When the form is completed and submitted, the Setup Page will give a cookie (or cookies) to the user to remember the set up choices, such as the URL of the Old Home Page.

The user sets his or her browser to treat the Setup Page as his or her new home page. The Setup Page gives instructions describing how a user would do this for Netscape Navigator or Microsoft's Internet Explorer.

In a preferred embodiment, the Setup Page may be a standard web page hard-coded in HTML. The HTML coding will generate a web page.

In an alternative embodiment, the Setup Page is created “on-the-fly” by a CGI script. When a user navigates his browser to the URL of the CGI script, the script will look for the cookie it gives each user. If the user doesn't have that cookie, the CGI script creates the Setup Page by generating HTML code, which will generate a web page on the user's browser.

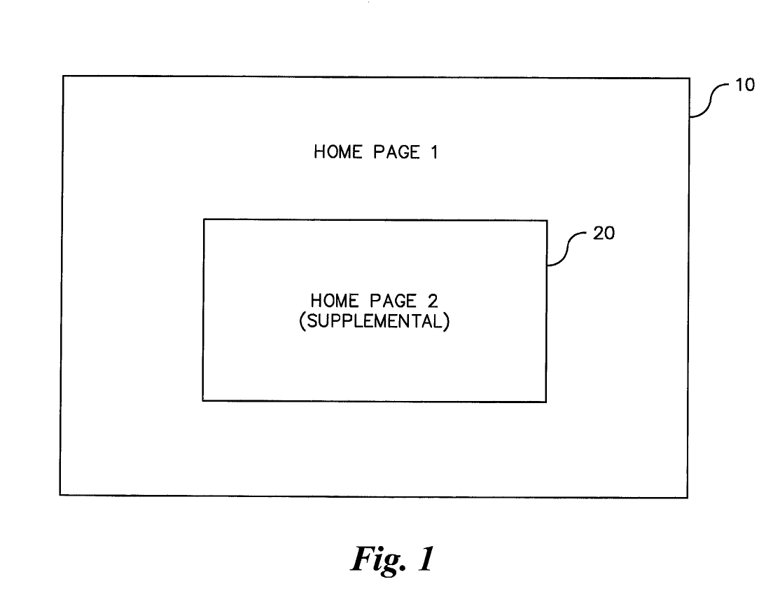

Subsequently (after a user has filled out the Sign Up Forms on the Setup Page, received a cookie with the user's preferences and the URL of the Old Home Page, and reset his home page to the Internet address of the Setup Page), when the user logs on to the Internet, his browser navigates to the URL of the Setup Page. This may be the Internet address of an actual HTML page or the address of a CGI script. The Setup Page (or CGI script) finds the cookie that it left, reads that cookie and doesn't show the Sign Up Forms. Instead, as shown in FIG. 1, it spawns the Floating Window 20 (as a child window to the main browser window) and then, by using scripting, redirects the original browser window (a parent window) to the Old Home Page 10. Scripting choices will determine whether the Floating Window 20 remains “on top of” the Old Home Page 10, or whether the Old Home Page 10 “covers” the Floating Window 20.

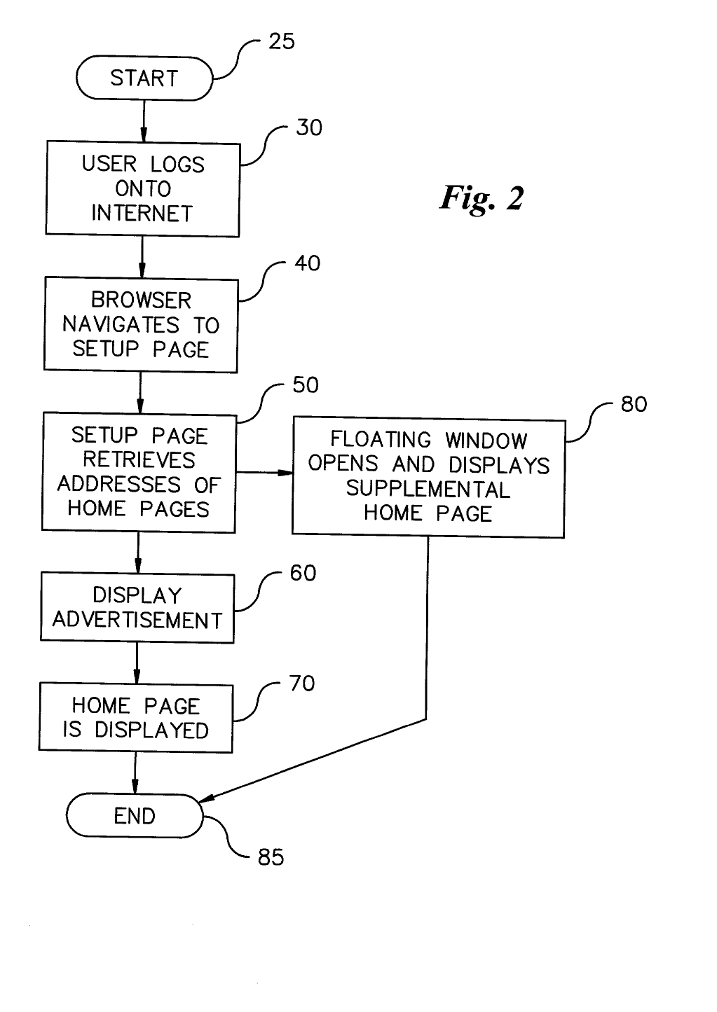

Referring to FIGS. 1 and 2, a method of supplementing the display of a desired home web page with a Floating Window on a display screen of a user's terminal starts at step 25. The user terminal's browser automatically navigates to the Setup Page address 40 in response to the user logging on to the Internet 30. The Setup Page automatically retrieves the home page address and the supplemental web page address 50. The Setup Page automatically launches a browser window and a Floating Window. The browser window displays the Old Home Page 70. The Floating Window displays the supplemental web page 80. In one embodiment, once the Floating Window is launched and it displays the supplemental web page address, the Setup Page then automatically causes itself to navigate to the Old Home Page address and display the Old Home Page 70. The method terminates at step 85.

In alternative embodiments, small helper window(s) or helper page(s) will be generated as intermediate steps that launch the Floating Window 20 or redirect themselves to the Old Home Page 10.

Prior to the redirect, the Setup Page may display advertising or other information, or may open up other windows to display such information. The Setup Page may also trigger programs that display advertising or information 60 while the Old Home Page 10 is being downloaded and displayed. After the redirect is accomplished, both the Floating Window 20 and the Old Home Page 10 are active.

In an alternative embodiment, the Setup Page may direct the user to navigate directly to his or her Old Home Page 10 and then navigate back using the back button. Scripting on the Setup Page can then automatically enter the URL of the Old Home Page 10 into the form (with or without user verification). In many computers this method is not available due to security issues. In other computers this method is available only when the user changes the security settings. There are other methods of automatically or semi-automatically entering the Old Home Page 10 which are know to those familiar with the art and intended to be encompassed in the present invention. There are various manual, automatic and semi-automatic methods for a user to make a web site his or her home page that are well-known to those familiar with the art and that are intended to be encompassed in the present invention.

The present invention as described above is deployed by a web site so that a user adds a Floating Window 20 from that site to his Old Home Page 10. In an alternative embodiment, the user deploys the present invention, creating a Floating Window 20 that accompanies his or her Old Home Page 10 and fills the Floating Window 20 with the web page of his choice. In this alternative embodiment, the user creates the Setup Page as a file or files on his own computer. The user fills in the URL of the Old Home Page 10 in one text field in one of the ways discussed above. The user then fills in the URL of another web page that the user wants to fill the Floating Window 20 (again, in one of the ways discussed above). The user then makes the Setup Page his or her new home page.

In an alternative embodiment, a user installs software on his or her own computer that automatically creates the Setup Page as a file or files. In another alternative embodiment, the software that the user installs on the computer generates an icon and installs it on a prominent part of the computer monitor. When the user is viewing a web page that he or she would like in a Floating Window with the home page, the user clicks (or double clicks) on the icon. This causes the software to add the URL of the page that the user is viewing to the Setup Page files on the user's computer.

The following is a printout of portions of a CGI script written in the Perl programming language. The script is a preferred embodiment of the present invention. Those portions of the script pertaining to a specific Old Home Page or specific Floating Window and not necessary for the novel aspects of the present invention have been deleted and replaced with comments on the material to be inserted. The omitted code will vary with the particular website and the Floating Window. Any programmer knowledgeable in the art of web page construction and CGI scripting using Perl script can easily construct the code necessary to implement the present invention.

> #!/˜˜˜/local/bin/perl
> #******************************************************
> # File: home.pl
> # Description: This script implements Home Page Plus!.
> # Invoking this script with invalid or no parameters
> # causes the generation of a StartUp Page. From
> # this StartUp Page, the user can enter all of his
> # information, including initial homepage URL, his
> # desired floating window to accompany that page,
> # and his name. When that page's form is filled out
> # and submitted, it again invokes this script which
> # then saves the parameters as cookies. From that
> # point on, whenever this script is invoked, it
> # outputs a HomePage. The HomePage simply invokes
> # one of the floating windows, and then redirects
> # itself to the user's original homepage URL.
> # © Copyright 2000
> #******************************************************
>
> # Get incoming parameters (if any)
> if ($ENV {‘REQUEST_METHOD’} eq ‘GET’)
> {
> @pairs = split(/&/, $ENV {‘QUERY_STRING’});
> }
> elsif ($ENV {‘REQUEST_METHOD’} eq ‘POST’)
> {
> read (STDIN, $buffer, $ENV {‘CONTENT_LENGTH’});
> @pairs = split(/&/, $buffer);
> }
> # Gather data
> foreach $pair (@pairs)
> {
> ($key, $value) = split (/=/, $pair);
> $key =˜ tr/+/ /;
> $key =˜ s/%([a-fA-F0-9] [a-fA-F0-9])/pack(“C”, hex($1))/eg;
> $value =˜ tr/+/ /;
> $value =˜ s/%([a-fA-F0-9] [a-fA-F0-9])/pack(“C”, hex($1))/eg;
> $value =˜s/<!−−(.|\n)*−−>//g;
>
> if ($formdata{$key})
> {
> $formada{$key} .= “, $value”;
> }
> else
> {
> $formdata{$key} = $value;
> }
> }
> $reset = $formdata {‘reset’};
> $newurl = $formdata{homeurl’};
> $newname = $formdata{‘nickname’};
> $newpronounce $formdata{‘pronounce’};
> $newhometext = $formdata{‘hometext’};
>
> $homeurl = ″″;
> $nickname = ″″;
> $pronounce = ″″;
> $hometext = ″″;
>
> # Read cookie, if it exists
> if($ENV {‘HTTP_COOKIE’})
> {
> @cookies = split (/;/,$ENV{‘HTTP_COOKIE’});
> foreach $ cookie (@cookies)
> {
> ($name, $value) = split (/=/, $cookie);
> $crumbs{$name} = $value;
> }
> $homeurl = $crumbs {‘homeurl’};
> $nickname = $crumbs {‘nickname’};
> $pronounce = $crumbs {‘pronounce’};
> $hometext $crumbs {‘hometext’};
> $getback = $crumbs{‘getback’};
> }
> # If user wants to reset data, the ‘reset’ parameter is
> # passed here as ‘true’. This results in the output of
> # an ‘Update Page’ which allows the user to change details
> # or cancel the HomePage Plus service altogether.
> f ($reset eq “true”)
> {
> # Make Update page
> &updatePage;
> exit;
> }
>
> # Update cookie with valid parameters
> if ($newname ne ″″)
> {
> print ″Set-Cookie:nickname=$newname; expires=Sun, 31-Dec-2100
> 00:00:00 GMT;\n″;
> $nickname = $newname;
> }
> $pronounce = $newpronounce;
> }
> if ($newhometext ne ″″)
> {
> print ″Set-Cookie:hometext=$newhometext; expires=Sun,
> 31-Dec-2100 00:00:00 GMT;\n″;
> $hometext = $newhometext;
> }
> if ($newurl ne ″″)
> {
> print ″Set-Cookie:homeurl=$newurl; expires=Sun, 31-Dec-2100
> 00:00:00 GMT;\n″;
> $homeurl = $newurl;
> }
>
> if($homeurl eq ″″)
> {
> # Incomplete data, so launch startup page
> &startupPage;
> }
> else
> {
> # Launch main home page
> &homePage;
> }
> exit;
> # **** END OF HOME.PL main *****
>
> sub homePage
> {
> # ***** Create Floating Page & Home Page (normal operation) *****
> #
> # The page created here is extremely simple, including one JavaScript
line to
> # invoke the correct floating window, and another line to redirect the
browser
> # to the user's original homepage URL.
>
> return;
> }
>
> sub startupPage
> {

> # ***** Create Startup WebPage (first-time page) ******
> #
> # This page collects the user's information by means of a form,
> # and then invokes this script again, passing it the correct
> # parameters:
> # homeurl -- the user's original homepage address (without http://)
> # hometext -- which floating window they prefer to accompany their
homepage
> # nickname -- the user's name or nickname
> # pronounce -- how to phonetically pronounce the nickname
>
> return;
> }
>
> sub updatePage
> {
> # ***** Create Update / Cancel Webpage *****
> #
> # From this page, the user can change details, or cancel the
> # HomePage Plus service altogether.
> #
>
> return;
> }
>
>
>

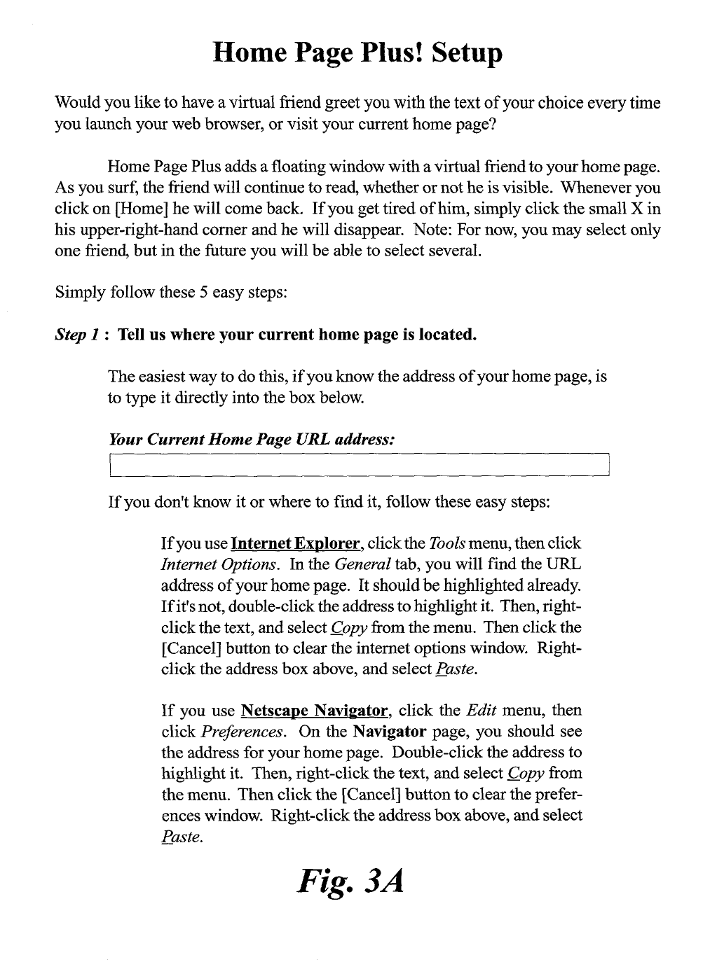

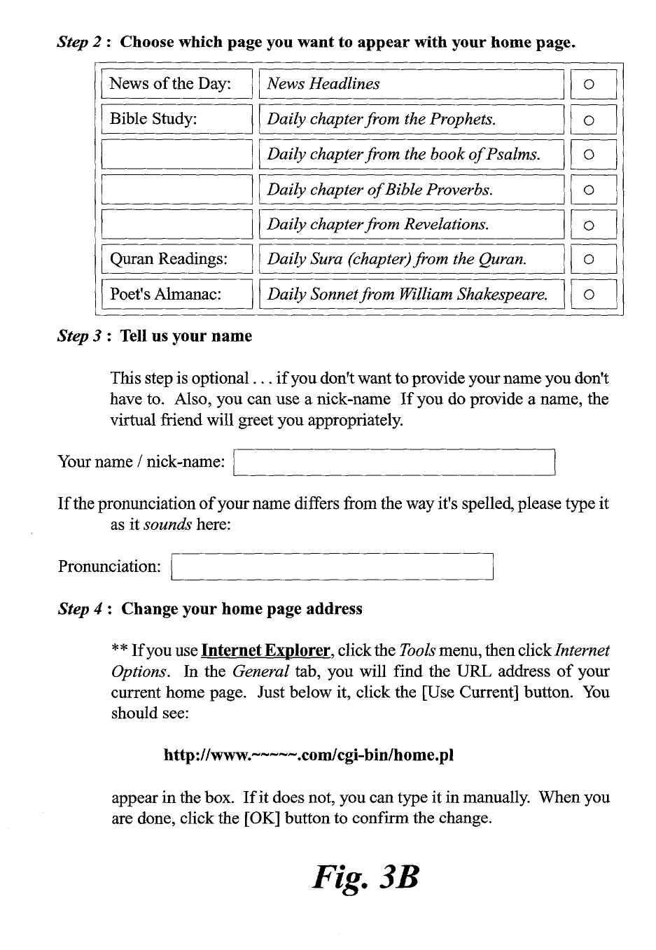

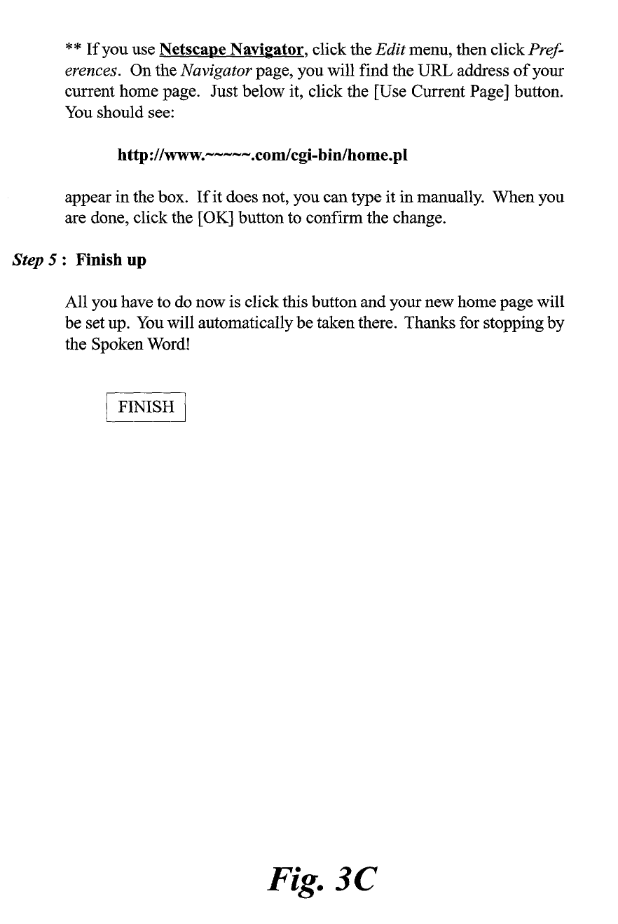

The following is a printout of HTML for a particular “Setup Page” (as shown in FIGS. 3A and 3B). The HTML is generated by some of the omitted portions of the CGI script shown above.

```
<HTML>
<!-- saved from url=(0036)http://www.˜˜˜˜˜.com/cgi-bin/home.pl −−>
<HEAD>
  <META NAME = “GENERATOR” CONTENT=“Adobe PageMill 3.0 Win”>
  <TITLE> Home Page Plus! Setup</TITLE>
  <META CONTENT=“text/html; charset=windows - 1252” HTTP-EQUIV=“Content-Type”>
</HEAD>
<BODY ALINK=“#00ff00” BGCOLOR=“#008080” LINK=“#00ff00” TEXT=“#ffffff”
VLINK=“#00f00”>
<FORM ACTION=“http://www.˜˜˜˜˜.com/cgi-bin/home.pl” ENCTYPE=“x-www-form-
urlencoded”
METHOD=“POST” NAME=“form 1” onsubmit=“return validate( );”>
<INPUT NAME=“hometext” TYPE=“hidden” VALUE=“Headllines”>
<P><CENTER><B><FONT COLOR=“#ffff00” SIZE=“+3”> Home Page Plus!</font><font
size=>1 ”5<sub>tm</sub></font>
Setup<BR>
</FONT></B></CENTER></P>
<P><CENTER><TABLE BORDER=“0” CELLPADDING=“0” CELLSPACING=“4”
WIDTH=“90%”>
  <TBODY>
  <TR>
  <TD WIDTH=“90%”>
  <P> Would you like to have a virtual friend greet you with
  the text of your choice every time you launch your web browser,
  or visit your current home page?<br><br>
  Home Page Plus<font size=“1”><sub> tm</sub> (patent pending) adds a floating window
with a virtual friend to your home page.
```

As you surf, the friend will continue to read, whether or not he is visible. Whenever you click on [Home] he will come back. If you get tired of him, simply click the small X in his upper-right-hand comer and he will disappear. Note: For now, you may select only one friend, but in the future you will be able to select several.

</P>
<P>Simply follow these 5 easy steps:</P>

<P><B><I><FONT COLOR=“#ffffff”>Step 1</FONT></I><FONT

COLOR=“#ffffff”>:</FONT></B><FONT

```
COLOR=“#ffffff”></FONT><B><FONT COLOR=“#fff00”> Tell
us where your current home page is located.</FONT></B></P>
<BLOCKQUOTE>
  <P><FONT COLOR=“#ffffff”> The easiest way to do this, if you
  know the address of your homepage, is to type it directly into the
  box below.</FONT></P>
  <P><B><I><FONT COLOR=“#ffffff”> Your Current Home Page
  URL address:<BR></FONT></I></B><FONT COLOR=“#ffffff”>
  <INPUT NAME=“homeurl” SIZE“66” TYPE=“text”></
  FONT></P>
  <P> If you don't know it or where to find it, follow these easy
steps:</P>
  <BLOCKQUOTE>
```

<P><FONT COLOR=“#ffffff”>If you use <B><U> Internet
Explorer</U></B>, click the </I> Tools </I> menu, then click
<I>Internet Options.
</I> &nbsp;In the <I>General</I> tab, you will find the URL
address of your home page. &nbsp;It should be highlighted
already. &nbsp;If it's not, double-click the address to highlight it.
&nbsp; Then, right-click the text, and select <I><U>C<U>opy</I>
from the menu. &nbsp;<I></I>Then click the [Cancel] button to
clear the internet options window. &nbsp;Right-click the address
box above, and select <I><U>P</U>aste.</I></FONT></P>
<P>If you use <B><U>Netscape Navigator</U>,</B> click the
<I>Edit</I>menu, then click <I/> Preferences. &nbsp;</I>On the
<B>Navigator</B> page, you should see the address for your
home page. &nbsp;<FONT COLOR=“ffffff”>Double-click the
address to highlight it. &nbsp;Then, right-click the text, and select
<I><U>C</U>opy</I> from the menu. &nbsp;<I></I>Then click
the [Cancel] button to clear the preferences window. &nbsp;Right-
click the address box above, and select <I><U>P</U> aste.
</I></FONT></P>

<BLOCKQUOTE>
<P><B><I><FONT COLOR=“#ffffff”>Step 2: </FONT></I><FONT

COLOR=“#ffff00”>Choose

which page you want to appear with your home page.
</FONT></B></P>
<BLOCKQUOTE>
<P><TABLE BORDER=“1” CELLPADDING=“2”

CELLSPACING=“5” WIDTH=“614”>

```
  <TBODY>
  <TR>
```

<TD WIDTH=“30%”>
<I>&nbsp;</I> News of the Day:</TD>
<TD WTDTH=“61%”>
<I>News Headlines</I></TD>
<TD WIDTH=“9%”>
&nbsp;<INPUT NAME=“headlines” onclick=“Update(‘head-
lines’)” TYPE=“radio” VALUE=“radio”></TD>

```
  <TR>
  <TR>
```

<TD WIDTH=“30%”>
&nbsp;Bible Study:</TD>
<TD WIDTH=“61%”>
</> Daily chapter from the Prophets/I></TD>
<TD WIDTH=“9%”>
&nbsp;<INPUT NAME=“prophets” onclick=“Update(‘prophets’)”
TYPE=“radio” VALUE=“radio”></TD>

```
  <TR>
  <TR>
  <TD WIDTH=“30%”>
  &nbsp;</TD>
  <TD WIDTH=“61%”>
  <I>Daily chapter from the Book of Psalms.</I></TD>
  <TD WIDTH=“9%”>
  &nbsp;<INPUT NAME=“psalm” onclick=“Update(‘psalm’)”
  TYPE=“radio”
  VALUE=“radio”></TD>
  </TR>
  </TR>
  <TD WIDTH=“30%”>
  &nbsp;</TD>
  <TD WIDTH=“61%”>
  I>Daily chapter of Bible Proverbs.</I></TD>
  <TD WIDTH=“9%”>
&nbsp;<INPUT NAME=“psalm” onclick=“Update(‘psalm’)”
TYPE=“radio” VALUE=“radio”></TD>
```

```
<TR>
<TR>
  <TD WIDTH=“30%”>
  &nbsp;</TD>
  <TD WIDTH=“61%”>
  </> Daily chapter from Revelations.</I></TD>
  <TD WIDTH=“9%”>
  &nbsp;<INPUT NAME=“revelation” onclick=“Update(‘revelation’)”
  TYPE=“radio” VALUE=“radio”></TD>
<TR>
<TR>
  <TD WIDTH=“30%”>
  &nbsp;Quran Readings:</TD>
  <TD WIDTH“61%”>
  </>Daily Sura (chapter) from the Quran.</I></TD>
  <TD WIDTH“9%”>
  &nbsp;<INPUT NAME=“quran” onclick=“Update(‘quran’)”
  TYPE=“radio” VALUE=“radio”></TD>
</TR>
</TR>
  <TD WIDTH“30%”>
```

&nbsp;Poet's Almanac:</TD>
<TD WIDTH=“61%”>
</>Daily Sonnet from William Shakespeare/I></TD>
<TD WIDTH=“9%”>
&nbsp ;<INPUT NAME=“sonnet” onclick=“Update(‘sonnet’)”
TYPE=“radio” VALUE=“radio”></TD>

</TR></TBODY>
</TABLE></P>

</BLOCKQUOTE>
<P><B><I><FONT COLOR=“#fffff”>Step 3: </FONT></I><FONT

COLOR=“#ffff00”>Tell

```
us your name</FONT></B></P>
<BLOCKQUOTE>
  <P><FONT COLOR=“#ffffff”>This step is optional . . . if you don't
  want to provide your name you don't have to. &nbsp;Also, you
  can use a nick-name. &nbsp;If you do provide a name, the virtual
  friend will greet you appropriately.</FONT></P>
  <P><FONT COLOR=“#ffffff”>Your name / nick-name: <INPUT
  NAME=“nickname”SIZE=“24” TYPE=“text”></FONT></P>
  <P> If the pronounciation of your name differs from the way it's
  spelled, please type it as it <I>sounds</I> here:</P>
  <P><FONT COLOR=“#ffffff”>Pronunciation: <INPUT
  NAME=“pronounce” SIZE=“24” TYPE=“text”></FONT></P>
<BLOCKQUOTE>
<P><B><I><FONT COLOR=“#ffffff”>Step 4: <FONT></I><FONT
```

COLOR=“#ffff00”>Change

```
your home page address</FONT></B></P>
<BLOCKQUOTE>
  <P><FONT COLOR=“#ffffff”>** If you use <B><U>Internet
  Explorer</U></B>, click the </>Tools </I>menu, then click
  <I>Internet Options.
  </I> &nbsp;In the <I>General</I> tab, you will find the URL
  address of your current home page. &nbsp;Just below it, click the
[Use Current] button. &nbsp;You should see:</FONT></P>
<BLOCKQUOTE>
  <P><B><FONT COLOR=“#ffffff”>http://www.˜˜˜˜˜.com/cgi-
```

bin/home.pl</FONT></B></P>

```
  </BLOCKQUOTE>
  <P><FONT COLOR=“#ffffff”>appear in the box. &nbsp;If it does
  not, you can type it in manually. &nbsp;When you are done, click
  the [OK] button to confirm the change.</FONT></P>
  <P> &nbsp;</P>
  <P><BR>
  <P><FONT COLOR=“#ffffff”>** If you use <B><U> Netscape
  Navigator</U> , </B>click the </>Edit </I> menu, then
  click <I>Preferences. </I>&nbsp;On the </>Navigator</I> page,
  you will find the URL address of your current home page. &nbsp;
  Just below it, click the [Use Current Page] button. &nbsp;You
  should see:</FONT></P>
  <BLOCKQUOTE>
```

<P> B><FONT COLOR=“#ffffff”>http://www.˜˜˜˜˜.com/cgi-

bin/home.pl</FONT></B></P>

```
  </BLOCKQUOTE>
  <P><FONT COLOR=“#ffffff”> appear in the box. &nbsp;If it does
  not, you can type it in manually. &nbsp;When you are done, click
  the [OK] button to confirm the change.</FONT></P>
  <P> &nbsp;</P>
</BLOCKQUOTE>
<P><B><I><FONT COLOR=“#ffffff”>Step 5: </FONT></I><FONT
```

COLOR=“#ffff00”>Finish

```
Up</FONT></B></P>
<BLOCKQUOTE>
  <P><FONT COLOR=“#ffffff”>All you have to do now is click this
  button and your new homepage will be set up. &nbsp;You will
  automatically be taken there. &nbsp;Thanks for stopping by
  the Spoken Word!</FONT></P>
```

<P><FONT COLOR=“#ffffff”><INPUT NAME=“finish”
TYPE=“submit” VALUE=“Finish”></FONT></P>

</BLOCKQUOTE>
</BLOCKQUOTE>
<P><CENTER><FONT SIZE=“−2”>Copyright (c)
1999-2000</FONT></CENTER></TD>

```
  </TR></TBODY>
</TABLE></CENTER></P>
<script language=“JavaScript⇄>
if (document.form1.homeurl.value == ″″)
{
  document.form1.homeurl.value window.history.next
}
if (document.form1.homeurl.value == “undefined”)
{
  document.form1.homeurl.value = ″″
}
hometext = “headlines”
if (hometext == “prophets”)
  document.form1.prophets.checked = true
else if (hometext == “psalm”)
  document.form1.psalm.checked = true
else if (hometext == “proverb”)
  document.form1.proverb.checked = true
else if (hometext == “revelation”)
  document.form1.revelation.checked = true
else if (hometext == “quran”)
  document.form1.quran.checked = true
else if (hometext == “sonnet”)
  document.form1.sonnet.checked = true
else
  document.form1.headlines.checked = true
document.form1.hometext.value = hometext
function Update(hometext)
{
  if (hometext != “headlines”)
```

document.form1.headlines.checked = false

if (hometext != “prophets”)

document.form1.prophets.checked = false

if (hometext != “psalm”)

document.form1.psalm.checked = false

if (hometext != “proverb”)

document.form1.proverb.checked = false

if (hometext != “revelation”)

document.form1.revelation.checked = false

if (hometext != “quran”)

document.form1.quran.checked = false

if (hometext != “sonnet”)

document.form1.sonnet.checked = false

```
  document.form1.hometext.value = hometext
}
function SetCookie(name, value)
{
  expireDate = new Date
expireDate.setMonth(expireDate.getMonth( )+6)
document.cookie = name + “=” + value + “;expires=” +
expireDate.toGMTString( )
}
function ReadCookie(name)
{
  answer = ″″
  if(document.cookie != ″″)
  {
```

thisCookie = document.cookie.split(″; ″)
i = 0;
while (i<thisCookie.length)
{

if (thisCookie[i].split(“=”)[0] == name)
{

answer = thisCookie[i]. split(“=”)[1]

}
i++;

}

```
  }
  return answer;
}
function validate( )
{
  if (document.form1.homeurl.value == ″″ ∥
  document.form1.homeurl.value == “undefined”)
  {
```

alert(“The URL is empty . . . go back to Step 1”);
return false;

```
  }
  SetCookie(“getback”, ″″);
  // strip http
  newurl = document.form1.homeurl.value
  if (newurl.substr(0,7) == “http://”)
  {
```

newurl = newurl.substr(7, newurl.length)
document.form1.homeurl.value = newurl

```
  }
  return true;
  }
  </script>
  </BODY>
  </HTML>
```

FIGS. 3A and 3B, taken together, show an example of a “Setup Page” format as it may appear on a browser.

The present invention may be implemented with any combination of hardware and software. The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of supplementing the display of a desired home web page with a floating window on a display screen of a user's terminal by using a setup web page having an address, the setup page having access to an address of the home page and an address of a supplemental web page to be displayed in the floating window, the method comprising:
(a) a browser of the user's terminal automatically navigating to the setup page address when the user logs onto the Internet;
(b) the setup page automatically retrieving the home page address and the supplemental web page address; and
(c) automatically launching a browser window and the floating window, wherein the browser window displays the home page, and the floating window displays the supplemental web page.

2. The method of claim 1, wherein the user's terminal stores a cookie file including the home page address and the supplemental web page address, the method further comprising:
(d) the setup page using address information in the cookie file to automatically cause the home page and the supplemental web page to be displayed.

3. The method of claim 1, wherein the setup page is located in a file on the user's terminal or is remotely located from the user's terminal.

4. The method of claim 1, wherein the setup page opens up at least one other window on the user's display screen to display advertising or other information.

5. The method of claim 1, further comprising:
(d) the user selecting the supplemental web page by clicking on a displayed page element while visiting the supplemental web page, wherein the page element is selected from the group consisting of an icon, a link and a button; and
(e) automatically storing the address of the supplemental web page in a file on a remote server or in a cookie file in the user's terminal.

6. The method of claim 1, wherein the setup page is an HTML page.

7. The method of claim 1, wherein the setup page is a CGI script.

8. The method of claim 7, wherein the CGI script is configured such that the floating window appears in the foreground of the display screen, and the home page appears in the background of the display screen.

9. A method of supplementing the display of a desired home web page with a floating window on a display screen of a user's terminal by using a setup web page having an address, the setup page having access to an address of a supplemental web page to be displayed in the floating window, the method comprising:
(a) a browser of the user's terminal automatically navigating to the setup page address when the user logs onto the Internet;
(b) the setup page receiving the supplemental web page address; and
(c) automatically launching the floating window, wherein the floating window displays the supplemental web page.

10. The method of claim 9, wherein the user's terminal stores a cookie file including the supplemental web page address, the method further comprising:
(d) the setup page using address information in the cookie file to automatically cause the supplemental web page to be displayed.

11. An article of manufacture for supplementing the display of a desired home web page with a floating window on a display screen of a user's terminal by using a setup web page having an address, the setup page having access to an address of the home page and an address of a supplemental web page to be displayed in the floating window, the article of manufacture comprising a computer-readable medium holding computer-executable instructions for performing a method comprising:
(a) a browser of the user's terminal automatically navigating to the setup page address when the user logs onto the Internet;
(b) the setup page automatically retrieving the home page address and the supplemental web page address; and
(c) automatically launching a browser window and the floating window, wherein the browser window displays the home page, and the floating window displays the supplemental web page.

12. The article of manufacture of claim 11, wherein the user's terminal stores a cookie file including the home page address and the supplemental web page address, and the computer-executable instructions perform a method further comprising:
(d) the setup page using address information in the cookie file to automatically cause the home page and the supplemental web page to be displayed.

13. The article of manufacture of claim 11, wherein the setup page is located in a file on the user's terminal or is remotely located from the user's terminal.

14. The article of manufacture of claim 11, wherein the setup page opens up at least one other window on the user's display screen to display advertising or other information.

15. The article of manufacture of claim 11, wherein the computer-executable instructions perform a method further comprising:
(d) the user selecting the supplemental web page by clicking on a displayed page element while visiting the supplemental web page, wherein the page element is selected from the group consisting of an icon, a link and a button; and
(e) automatically storing the address of the supplemental web page in a file on a remote server or in a cookie file in the user's terminal.

16. The article of manufacture of claim 11, wherein the setup page is an HTML page.

17. The article of manufacture of claim 11, wherein the setup page is a CGI script.

18. The article of manufacture of claim 17, wherein the CGI script is configured such that the floating window appears in the foreground of the display screen, and the home page appears in the background of the display screen.

19. An article of manufacture for supplementing the display of a desired home web page with a floating window on a display screen of a user's terminal by using a setup web page having an address, the setup page having access to an address of a supplemental web page to be displayed in the floating window, the article of manufacture comprising a computer-readable medium holding computer-executable instructions for performing a method comprising:
(a) a browser of the user's terminal automatically navigating to the setup page address when the user logs onto the Internet;
(b) the setup page receiving the supplemental web page address; and
(c) automatically launching the floating window, wherein the floating window displays the supplemental web page.

20. The article of manufacture of claim 19, wherein the user's terminal stores a cookie file including the supplemental web page address, and the computer-executable instructions perform a method further comprising:
(d) the setup page using address information in the cookie file to automatically cause the supplemental web page to be displayed.
